(19) United States
(12) Patent Application Publication
(10) Pub. No.: US 2015/0288970 A1
(43) Pub. Date: Oct. 8, 2015

(54) VIDEO ENCODING METHOD AND APPARATUS FOR PARALLEL PROCESSING USING REFERENCE PICTURE INFORMATION, AND VIDEO DECODING METHOD AND APPARATUS FOR PARALLEL PROCESSING USING REFERENCE PICTURE INFORMATION

(71) Applicants: SAMSUNG ELECTRONICS CO., LTD., Gyeonggi-do (KR); INDUSTRY-ACADEMIC COOPERATION FOUNDATION, YONSEI UNIVERSITY, Seoul (KR)

(72) Inventors: Young-o Park, Seoul (KR); Kwang-pyo Choi, Anyang-si (KR); Chan-yul Kim, Bucheon-si (KR); Byeong-doo Choi, Siheung-si (KR); Won-woo Ro, Seoul (KR); Kyung-ah Kim, Seoul (KR); Deok-ho Kim, Seoul (KR); Min-woo Kim, Seoul (KR)

(73) Assignees: SAMSUNG ELECTRONICS CO., LTD., Suwon-si (KR); INDUSTRY-ACADEMIC COOPERATION FOUNDATION, YONSEI UNIVERSITY, Seoul (KR)

(21) Appl. No.: 14/432,081

(22) PCT Filed: Sep. 30, 2013
(86) PCT No.: PCT/KR2013/008754

§ 371 Date: Mar. 27, 2015

Related U.S. Application Data
(60) Provisional application No. 61/706,953, filed on Sep. 28, 2012.

(51) Int. Cl. H04N 19/159; H04N 19/124; H04N 19/44; H04N 19/91; H04N 19/51

(52) U.S. Cl. CPC H04N 19/159; H04N 19/91; H04N 19/51; H04N 19/44; H04N 19/124

(57) ABSTRACT

Provided is a video encoding method for a parallel process. The video encoding method includes performing an inter prediction and an intra prediction for pictures included in a group of picture (GOP) and determining an encoding order and reference dependency between the pictures included in the GOP, and generating a predetermined data unit including reference relation information generated based on the encoding order and reference dependency between the pictures included in the GOP.

### RELATED APPLICATIONS

This application claims the benefit of U.S. Provisional Application No. 61/706,953, filed on Sep. 28, 2012, in the US Patent Office, the disclosures of which are incorporated herein in their entireties by reference.

### BACKGROUND

1. Field

One or more exemplary embodiments relate to a parallel encoding and parallel decoding scheme of a video.

2. Description of the Related Art

Recently, as a digital display technology develops and high quality digital TVs are widely used, new codecs for processing mass video data have been suggested. Further, recently, as hardware performance develops, a CPU or GPU for performing a video image process is formed as a multi-core, thereby allowing a parallel image data process at the same time.

### SUMMARY

One or more exemplary embodiments include including information on a reference relation between pictures in a predetermined data transmission unit so as to be transmitted.

Additional aspects will be set forth in part in the description which follows and, in part, will be apparent from the description, or may be learned by practice of the presented exemplary embodiments.

According to one or more exemplary embodiments, a video encoding method for a parallel process includes: performing an inter prediction and an intra prediction for pictures included in a group of picture (GOP) and determining an encoding order and reference dependency between the pictures included in the GOP; and generating a predetermined data unit including reference relation information generated based on the encoding order and reference dependency between the pictures included in the GOP.

According to one or more exemplary embodiments, a video encoding apparatus for a parallel process includes: an image encoder which performs an inter prediction and an intra prediction for pictures included in a group of picture (GOP) and determines an encoding order and reference dependency between the pictures included in the GOP; and an output unit which generates a predetermined data unit including reference relation information generated based on the encoding order and reference dependency between the pictures included in the GOP.

According to one or more exemplary embodiments, a video decoding method for a parallel process includes: obtaining a predetermined data unit including reference relation information generated based on a decoding order and reference dependency between pictures included in a group of picture (GOP); determining pictures which may be processed in parallel from among pictures included in the GOP, based on reference relation information included in the data unit; and decoding the determined pictures in parallel.

According to one or more exemplary embodiments, a video decoding apparatus for a parallel process includes: a receiver which obtains a predetermined data unit including reference relation information generated based on a decoding order and reference dependency between pictures included in a group of picture (GOP); and an image decoder which determines pictures which may be processed in parallel from among pictures included in the GOP, based on reference relation information included in the data unit, and decodes the determined pictures in parallel.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a block diagram of a video encoding apparatus based on an coding unit of a tree structure, according to an embodiment of the present invention;

FIG. 2 is a block diagram of a video decoding apparatus based on an coding unit of a tree structure, according to an embodiment of the present invention;

FIG. 3 illustrates a concept of an coding unit according to an embodiment of the present invention;

FIG. 4 is a block diagram of an image encoder based on an coding unit according to an embodiment of the present invention;

FIG. 5 is a block diagram of an image decoder based on an coding unit according to an embodiment of the present invention;

FIG. 6 illustrates an coding unit and partition according to depths according to an embodiment of the present invention;

FIG. 7 illustrates the relation between the coding unit and the transformation unit according to an embodiment of the present invention;

FIG. 8 illustrates encoding information according to depths, according to an embodiment of the present invention;

FIG. 9 illustrates the coding unit according to depths according to an embodiment of the present invention;

FIGS. 10, 11, and 12 illustrate the relation between the coding unit, the prediction unit, and the transformation unit, according to an embodiment of the present invention;

FIG. 13 illustrates the relation between the coding unit, the prediction unit, and the transformation unit according to encoding mode information of Table 1;

FIG. 14 is a block diagram of a video encoding apparatus for a parallel process according to an embodiment of the present invention;

FIG. 15 illustrates the type of NAL unit according to an embodiment of the present invention;

FIG. 16 illustrates a hierarchical GOP structure according to an embodiment of the present invention;

FIG. 17 illustrates a reference dependency tree (RDT) for pictures included in the hierarchical GOP structure of FIG. 16;

FIG. 18 is a flowchart illustrating a video encoding method for a parallel process, according to an embodiment of the present invention;

FIG. 19 is a block diagram of a video decoding apparatus for a parallel process according to an embodiment of the present invention;

FIG. 20 is a flowchart illustrating a video decoding method for a parallel process according to an embodiment of the present invention;

FIG. 21 illustrates a multi-threading program for a parallel process according to an embodiment of the present invention;

FIG. 22 illustrates a thread execution process in a multi-threading program which uses a lock or semaphore; and

FIG. 23 is a flowchart illustrating a synchronization process of a multi-threading program according to an embodiment of the present invention.

### DETAILED DESCRIPTION

Reference will now be made in detail to exemplary embodiments, examples of which are illustrated in the accompanying drawings, wherein like reference numerals refer to like elements throughout. In this regard, the present exemplary embodiments may have different forms and should not be construed as being limited to the descriptions set forth herein. Accordingly, the exemplary embodiments are merely described below, by referring to the figures, to explain aspects of the present description. Expressions such as “at least one of,” when preceding a list of elements, modify the entire list of elements and do not modify the individual elements of the list.

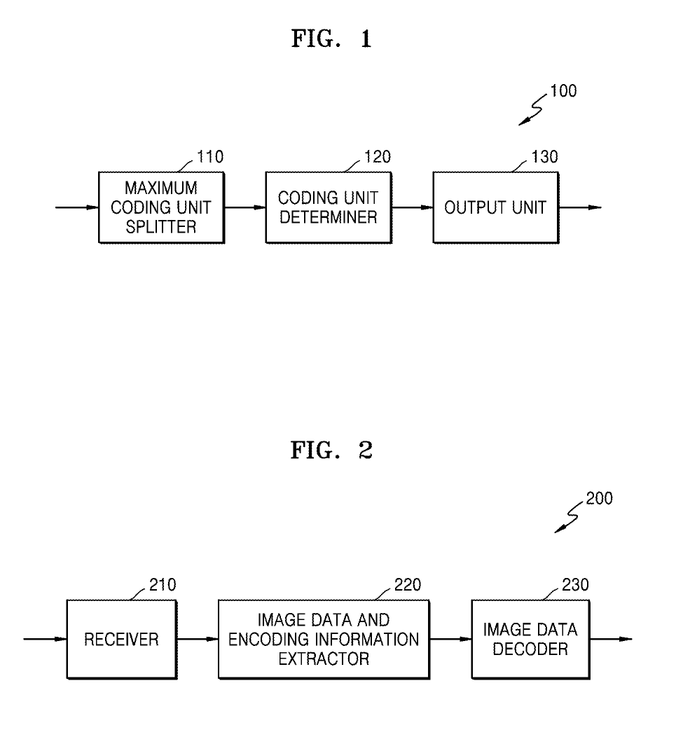

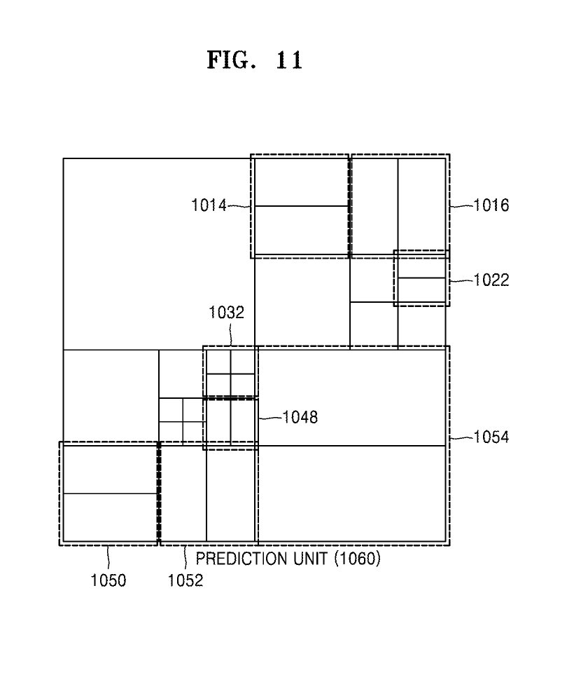

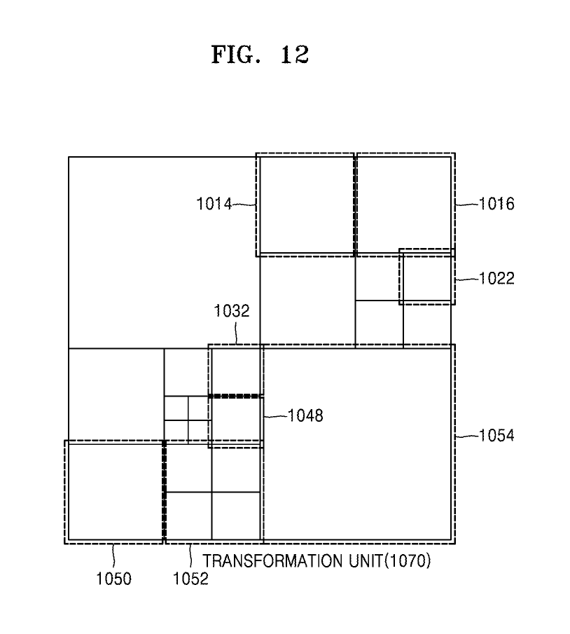

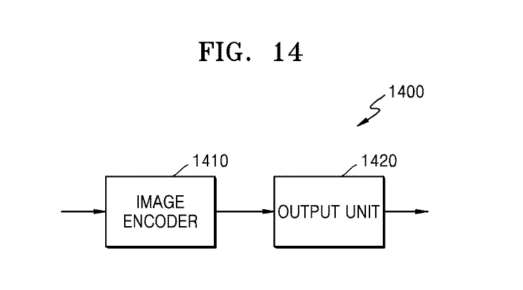

Hereinafter, a video encoding scheme and a video decoding scheme based on the coding unit of a tree structure according to an embodiment of the present invention will be described with reference to FIGS. 1 to 13. Further, a scheme of encoding and decoding a video for a parallel process according to an embodiment of the present invention will be described with reference to FIGS. 14 to 23.

First, a video encoding scheme and a video decoding scheme based on an coding unit of a tree structure will be described with reference to FIGS. 1 to 13.

FIG. 1 is a block diagram of a video encoding apparatus 100 based on an coding unit of a tree structure, according to an embodiment of the present invention.

The video encoding apparatus 100, which accompanies video prediction based on the coding unit according to the tree structure according to an embodiment of the present invention, includes a maximum coding unit splitter 110, an coding unit determiner 120, and an output unit 130. Hereinafter, the video encoding apparatus 100 which accompanies video prediction based on the coding unit according to the tree structure according to an embodiment of the present invention will be referred to as the video encoding apparatus 100 for the convenience of explanation.

The maximum coding unit splitter 110 may obtain the current picture based on the maximum coding unit which is the maximum size coding unit for the current picture of the image. If the current picture is greater than the maximum coding unit, image data of the current picture may be split in at least one maximum coding unit. The maximum coding unit according to an embodiment of the present invention is the data unit such as 32×32, 64×64, 128×128, and 256×256, and may be the data unit of a square of which the size of the length and breadth is a square of 2. Image data may be output to the coding unit determiner 120 by at least one maximum coding unit.

The coding unit according to an embodiment of the present invention may be featured by the maximum size and depth. The depth refers to the number of times by which the coding unit is spatially split, and as the depth increases, the coding unit according to depths may be portioned from the maximum coding unit to the minimum coding unit. The depth of the maximum coding unit is the uppermost depth, and the minimum coding unit may be defined as the lowest coding unit. With respect to the maximum coding unit, as the depth increases, the size of the coding unit according to depths decreases, and thus the coding unit of the upper depth may include the coding units of the plurality of lower depths.

As described above, image data of the current picture are split in the maximum coding unit according to the maximum size of the coding unit, and each maximum coding unit may include coding units which are split according to depths. The maximum coding unit according to an embodiment of the present invention is split according to depths, and thus the image data of the spatial domain included in the maximum coding unit may be hierarchically classified according to the depth.

The maximum size of the coding unit and the maximum depth which limits the total number of times for hierarchically splitting the height and the width of the maximum coding unit may have been preset.

The coding unit determiner 120 encodes at least one split area which is made by the split of the area of the maximum coding unit according to depths so as to determine the depth at which the final encoding result is to be output by at least one split area. That is, the coding unit determiner 120 encodes the image data in coding units according to depths for each maximum coding unit of the current picture and selects the depth at which the smallest encoding error is generated so as to determine the encoding depth. Image data by maximum coding units and the determined encoding depth are output to the output unit 130.

The image data within the maximum coding unit is encoded based on the coding unit according to depths according to at least one depth less than the maximum depth, and the encoding results based on the coding unit according to depths are compared. As a result of the encoding error in the coding unit according to depths, the depth with the smallest encoding error may be selected. At least one encoding depth may be determined for respective maximum coding units.

The size of the maximum coding unit is split by hierarchically splitting the coding unit as the depth increases, and the number of coding units increases. Further, even for the coding units of the same depth included in one maximum coding unit, the encoding error for respective data is measured and whether to be split to the lower depth is determined. Hence, even data included in one maximum coding unit have different encoding errors according to depths according to the location, and thus the encoding depths may be differently determined. Hence, one or more depths may be set for one maximum coding unit, and the data of the maximum coding unit may be split according to the coding unit of one or more encoding depths.

Hence, the coding unit determiner 120 according to an embodiment of the present invention may determine coding units according to the tree structure included in the currently maximum coding unit. The coding units according to the tree structure according to an embodiment of the present invention include coding units of the depth which has been determined as the encoding depth from among coding units by all depths included in the currently maximum coding unit. The coding unit of the encoding depth may be hierarchically determined according to the depth in the same area and may be independently determined in other areas within the maximum coding unit. Likewise, the encoding depth for the current area may be determined independently from the encoding depth for other areas.

The maximum depth according to an embodiment of the present invention is an index related with the number of splits from the maximum coding unit to the minimum coding unit. The first maximum depth according to an embodiment of the present invention may indicate the total number of splits from the maximum coding unit to the minimum coding unit. The second maximum depth according to an embodiment of the present invention may indicate the total number of depth levels from the maximum coding unit to the minimum coding unit. For example, when the depth of the maximum coding unit is 0, the depth of the coding unit in which the maximum coding unit has been split once is determined as 1, and the depth of the coding unit which has been split twice is determined is 2. Here, if the coding unit which has been split four times from the maximum coding unit is the minimum coding unit, depth levels of depths 0, 1, 2, 3, and 4 exist, and thus the first maximum depth may be set to 4, and the second maximum depth may be set to 5.

The prediction encoding and transformation of the maximum coding unit may be performed. The prediction encoding and transformation may also be performed based on the coding unit according to depths for each depth less than the maximum depth for each maximum coding unit.

Whenever the maximum coding unit is split according to depths, the number of coding units according to depths increases, and thus the prediction encoding and transformation need to be performed for all coding units for all depths which are generated as the depth increases. Hereinafter, the prediction encoding and transformation will be described based on the coding unit of the current depth from among one or more maximum coding units for the convenience of explanation.

The video encoding apparatus 100 according to an embodiment of the present invention may variously select the size or form of the data unit for the encoding of image data. Operations such as the prediction encoding, transformation, and entropy encoding are performed for the encoding of image data, and the same data unit may be used for all operations, or different data units may be used for different operations.

For example, the video encoding apparatus 100 may select a data unit other than the coding unit in order to perform the prediction encoding of the image data of the coding unit as well as the coding unit for the encoding of the image data.

In order to perform prediction encoding of the maximum coding unit, the prediction encoding may be performed based on the coding unit of the encoding depth, i.e., the coding unit which is not split any more according to an embodiment of the present invention. Hereinafter, the coding unit, which is not split any more and becomes the basis of the prediction encoding, is referred to as the prediction unit. The partition, which is made by splitting the prediction unit, may contain the prediction unit and the data unit which is made by splitting at least one of the height and width of the prediction. The partition may be a data unit in the form of split of the prediction unit of the coding unit, and the prediction unit may be the partition of the same size as that of the coding unit.

For example, when the coding unit of the size of 2N×2N (here, N is a positive integer) is not split any more, the prediction unit size becomes 2N×2N, and the partition size may be 2N×2N, 2N×N, N×2N, N×N, etc. The partition type according to an embodiment of the present invention may selectively include symmetrical partitions which are split by the symmetric ratio of the height or width of prediction units, partitions which are split by symmetric ratios such as 1:n or n:1, and partitions which are split in a geometrical form, and partitions in an arbitrary form.

The prediction mode of the prediction unit may be at least one of the intra mode, the inter mode, and the skip mode. For example, the intra mode and the inter mode may be performed for the partitions of sizes of 2N×2N, 2N×N, N×2N, and N×N. Further, the skip mode may be performed for only the partition of the size of 2N×2N. The encoding may be independently performed per one prediction unit within the coding unit so that the prediction mode with the smallest encoding error may be selected.

Further, the video encoding apparatus 100 according to an embodiment of the present invention may perform convention of the image data in the coding unit based on the data unit other than the coding unit as well as the coding unit for the encoding of the image data. The transformation may be performed based on the transformation unit of the size smaller than or the same as that of the coding unit for the transformation of the coding unit. For example, the transformation unit may include the data unit for the intra mode and the transformation unit for the inter mode.

In a scheme similar to that in the coding unit according to the tree structure according to an embodiment of the present invention, the transformation unit within the coding unit may be split recursively in transformation units of a smaller size and the residual data in the coding unit may be split according to the transformation unit according to the tree structure according to the transformation depth.

Even with respect to the transformation unit according to an embodiment of the present invention, the transformation depth, which indicates the number of times of split up to the transformation unit by splitting the height and the width of the coding unit, may be set. For example, if the size of the transformation unit of the current coding unit of the size 2N×2N is 2N×2N, the transformation depth may be set to 0, and if the size of the transformation unit is N×N, the transformation depth may be set to 1, and if the transformation unit is N/2×N/2, the transformation depth may be set to 2. That is, with respect to the transformation unit, the transformation unit according to the tree structure may be set according to the transformation depth.

With respect to encoding information for respective encoding depths, the prediction-related information and transformation-relation information as well as the encoding depth are needed. Hence, the coding unit determiner 120 may determine the partition type by which the prediction unit has been split, the prediction mode for respective prediction units, and the size of the transformation unit for transformation as well as the encoding depth at which the minimum encoding error has been generated.

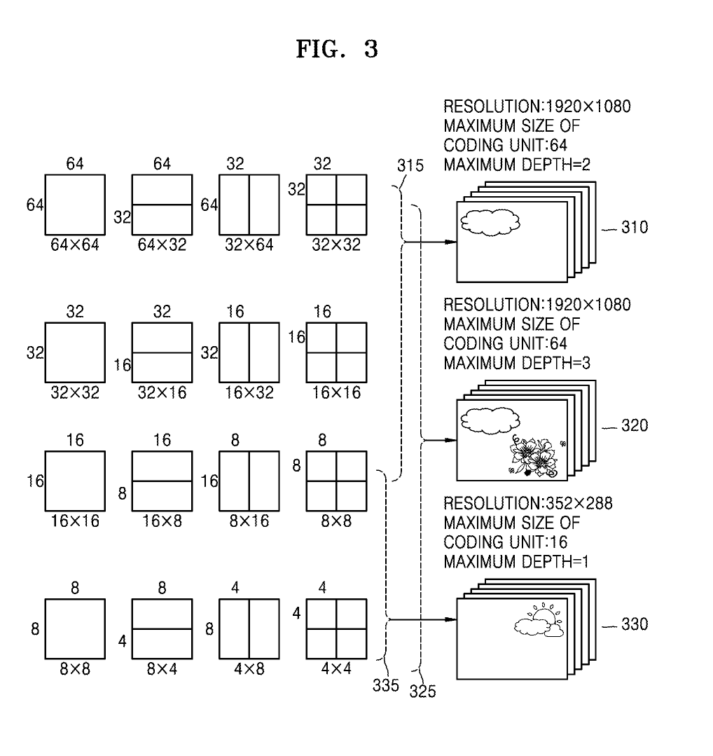

The scheme of determining the coding unit, prediction unit/partition, and transformation unit according to the tree structure of the maximum coding unit according to an embodiment of the present invention will be described with reference to FIGS. 3 to 13.

The coding unit determiner 120 may measure the encoding error of the coding unit according to depths by using the rate-distortion optimization scheme based on Lagrangina Multiplier.

The output unit 130 outputs encoded image data of the maximum coding unit and information on the encoding mode for respective depths based on at least one encoding depth which has been determined in the coding unit determiner 120 in the form of a bit stream.

The encoded image data may be the result of encoding of residual data of the image.

The information on the encoding mode according to depths may include encoding depth information, partition type information of the prediction unit, prediction mode information, and size information of the transformation unit.

The encoding depth information may be defined by using split information according to depths indicating whether to be encoded in the coding unit of the lower depth without encoding with the current depth. If the current depth of the current coding unit is the encoding depth, the current coding unit is encoded in the coding unit of the current depth, and thus the split information of the current depth may be defined not to be split in the lower depth any more. In contrast, if the current depth of the current coding unit is not the encoding depth, the encoding by using the coding unit of the lower depth may need to be tried, and thus the split information of the current depth may be defined to be split in the coding unit of the lower depth.

If the current depth is not the encoding depth, the encoding is performed for the coding unit which has been split in the coding unit of the lower depth. There is one or more coding units of the lower depth within the coding unit of the current depth, and thus the encoding is repeatedly performed for each coding unit of each lower depth and thereby the recursive encoding may be performed for each coding unit of the same depth.

The coding units of the tree structure in one maximum coding unit are determined and information on at least one encoding mode for each coding unit of the encoding depth needs to be determined, and thus information on at least one encoding mode may be determined for one maximum coding unit. Further, data of the maximum coding unit may be hierarchically split according to the depth and the encoding depth may be different by positions, and thus the information about the encoding depth and encoding mode may be set for data.

Hence, in the output unit 130 according to an embodiment of the present invention, encoding information on the encoding depth and the encoding mode may be allocated for at least one of the coding unit, prediction unit, and the minimum unit contained in the maximum coding unit.

The minimum unit according to an embodiment of the present invention is the data unit of a square of a 4-split size of the minimum coding unit which is the lowest encoding depth. The minimum unit according to an embodiment of the present invention may be the square data unit of the maximum size which may be included in all coding units included in the maximum coding unit, prediction unit, partition unit, and transformation unit.

For example, encoding information, which is output through the output unit 130, may be classified as encoding information for respective coding units according to depths and encoding information for respective prediction units. The encoding information for respective coding units according to depths may include prediction mode information and partition size information. The encoding information, which is transmitted by prediction units, may include information on the estimation direction of the inter mode, information on the reference image index of the inter mode, information about the motion vector, information about chroma elements of the intra mode, and information about the interpolation scheme of the intra mode.

Information on the maximum size of the coding unit and information on the maximum depth, which are defined for respective pictures, slices, or GOPs, may be inserted into the header of the bit stream, the sequence parameter set, or the picture parameter set.

Further, information on the maximum size of the transformation unit and information on the minimum size of the transformation unit, which are allowed for the current video, may also be output through the header of the bit stream, the sequence parameter set, or the picture parameter set. The output unit 130 may encode reference information related with the prediction described with reference to FIGS. 1 to 6, prediction information, single direction prediction information, and slice type information including the fourth slice type, etc. so as then to be outputted.

According to an embodiment of the simplest form of the video encoding apparatus 100, the coding unit for respective depths is the coding unit of the size of the half of the height and width of the coding unit of one layer higher depth. That is, if the size of the coding unit of the current depth is 2N×2N, the size of the coding unit of the lower depth is N×N. Further, the current coding unit of the size of 2N×2N may include up to 4 lower depth coding units of N×N size.

Hence, the video encoding apparatus 100 may determine the coding unit of the optimal forma and size for respective maximum coding units based on the maximum coding unit size and the maximum depth which have been determined in consideration of the characteristics of the current picture so as to form coding units according to the tree structure. Further, encoding may be performed in various prediction modes and transformation schemes for respective maximum coding units, and thus the optimal encoding mode may be determined in consideration of the image characteristics of the coding units of various image sizes.

Hence, if an image of a very high resolution or a very large amount of data is encoded in the existing macroblock units, the number of macroblocks for each picture becomes excessively large. As such, the compression information, which is generated for each macroblock, also increases, and thus the transmission load of the compression information may increase and the compression efficiency may decrease. Hence, the video encoding apparatus according to an embodiment of the present invention may increase the maximum size of the coding unit in consideration of the image size and adjust the coding unit in consideration of image characteristics, and thus the image compression efficiency may increase.

FIG. 2 is a block diagram of a video decoding apparatus based on an coding unit of a tree structure, according to an embodiment of the present invention.

A video decoding apparatus 200, which accompanies video prediction based on the coding unit according to the tree structure, includes a receiver 210, an image data and encoding information extractor 220, and an image data decoder 230. Hereinafter, the video decoding apparatus 200, which accompanies video prediction based on the coding unit according to the tree structure, will be referred to as the video decoding apparatus 200 for the convenience of explanation.

The definitions of various terms such as the coding unit for the decoding operation of the video decoding apparatus 200, depth, prediction unit, transformation unit, and information about various encoding modes have already been described above with reference to FIG. 1 and the video encoding apparatus 100.

The receiver 210 receives and parses the bit stream on the encoded video. The image data and encoding information extractor 220 extracts encoded image data for respective coding units according to the coding units according to the tree structure for respective maximum coding units from the parsed bit stream so as to output the extracted image data to the decoder 230. The image data and encoding information extractor 220 may extract information on the maximum size of the coding unit of the current picture from the header on the current picture, the sequence parameter set, or the picture parameter set.

Further, the image data and encoding information extractor 220 extracts information the encoding depth and the encoding mode about coding units according to the tree structure for respective maximum coding units from the parsed bit stream. The information on the extracted encoding depth and encoding mode is output to the decoder 230. That is, the image data of the bit stream may be split in the maximum coding units so that the image data decoder 230 may decode image data for respective maximum coding units.

Information on the encoding depth and encoding mode for respective maximum coding units may be set for one or more encoding depth information sets, and the information on the encoding mode for respective encoding depths may include partition type information of the coding unit, prediction mode information, and size information of the transformation unit. Further, split information according to depths may be extracted as the encoding depth information.

The information on the encoding depth and encoding mode for respective maximum coding units, which have been extracted by the image data and encoding information extractor 220, is information about the encoding depth and encoding mode which have been determined as generating the minimum encoding error by repeatedly performing encoding for respective coding units by maximum coding units and depths. Hence, the video encoding apparatus 200 may decode data according to the encoding scheme which generates the minimum encoding error so as to restore images.

The encoding information on the encoding depth and the encoding mode according to an embodiment of the present invention may have been allocated for a predetermined data unit from among the coding unit, the prediction unit, and the minimum unit, and thus the image data and encoding information extractor 220 may extract information on the encoding depth and encoding mode for respective determined data units. If information on the encoding depth and encoding mode of the maximum coding unit has been recorded for respective data units, predetermined data units having information about the same encoding depth and encoding mode may be inferred as the data unit included in the same maximum coding unit.

The image data decoder 230 decodes image data of respective maximum decoders based on information on the encoding depth and encoding mode for respective maximum coding units so as to restore the current picture. That is, the image data decoder 230 may decode image data which has been encoded based on the read partition type, prediction mode, and transformation unit for respective coding units from among the coding units according to the tree structure included in the maximum coding unit. The decoding process may include the prediction process including the intra prediction and motion compensation, and the reverse-transformation process.

The image data decoder 230 may perform intra prediction and motion compensation according to respective partitions and prediction mode for respective coding units based on the partition type information and prediction mode information of prediction units of the coding units for respective encoding depths.

Further, the image data decoder 230 may read transformation unit information according to the tree structure for respective coding units and perform reverse transformation based on the transformation unit for the reverse transformation for respective maximum coding units. Through the reverse transformation, the pixel value of the space area of the coding unit may be restored.

The image data decoder 230 may determine the encoding depth of the current maximum coding unit by using split information according to depths. If the split information indicates that no further split is shown in the current depth, the current depth is the encoding depth. Hence, the image data decoder 230 may decode the coding unit of the current depth for the image data of the current maximum coding unit by using the partition type of the prediction unit, prediction mode, and transformation unit size information.

That is, encoding information, which has been set for the coding unit, prediction unit, and a predetermined data unit, is observed, the data units having encoding information including the same split information are collected, and the collection may be considered as one data unit to be decoded as the same encoding mode by the image data decoder 230. In this way, the decoding of the current coding unit may be performed by obtaining information on the encoding mode for respective determined coding units.

Hence, the video decoding apparatus 200 may obtain information on the coding unit which has generated the minimum encoding error by recursively performing encoding for respective maximum coding units in the encoding process so as to be used in the decoding for the current picture. That is, the decoding of encoded image data of the coding units according to the tree structure, which has been determined in the optimal coding units for respective maximum coding units, becomes possible.

Hence, even an image of a high resolution and an image of an excessively large data amount may be restored by efficiently restoring image data according to the encoding mode and the coding unit size which has been determined adaptively to the characteristics of the image by using information on the optimal encoding mode which has been transmitted from the encoding terminal.

FIG. 3 illustrates a concept of an coding unit according to an embodiment of the present invention.

The example of the coding unit is expressed as the width×height, and 32×32, 16×16, and 8×8 may be included from the coding unit of 64×64 size. The coding unit of 64×64 size may be split into partitions of 64×64, 64×32, 32×64, and 32×32, the coding unit of 32×32 size may be split into partitions of 32×32, 32×16, 16×32, and 16×16, the coding unit of 16×16 size may be split into partitions of 16×16, 16×8, 8×16, and 8×8, and the coding unit of size 8×8 may be split into partitions of 8×8, 8×4, 4×8, and 4×4.

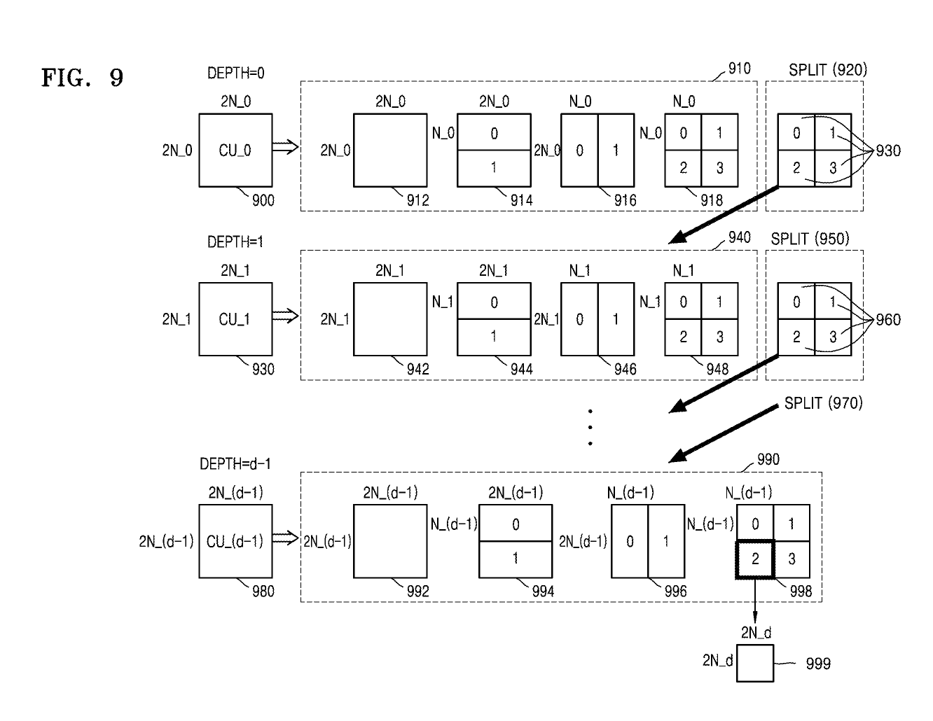

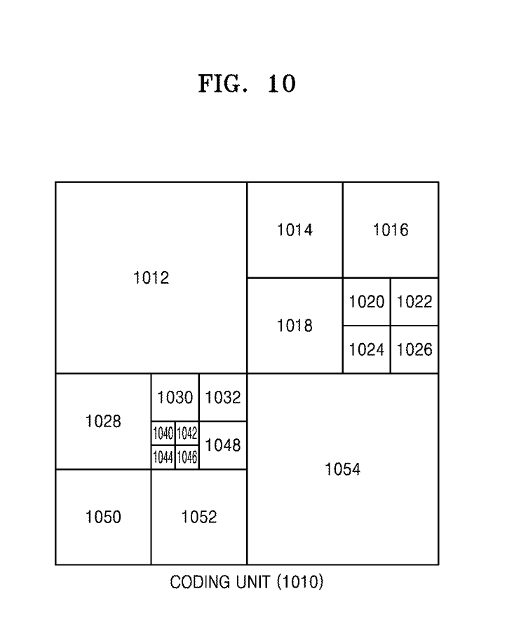

With respect to video data 310, the resolution has been set to 1920×1080, the maximum size of the coding unit has been set to 64, and the maximum depth has been set to 2. With respect video data 320, the resolution has been set to 1920×1080, the maximum size of the coding unit has been set to 64, and the maximum depth has been set to 3. With respect video data 330, the resolution has been set to 352×288, the maximum size of the coding unit has been set to 16, and the maximum depth has been set to 1. The maximum depth illustrated in FIG. 9 indicates the total number of splits from the maximum coding unit to the minimum coding unit.

When the resolution is high or the amount of data is large, it is preferred that the maximum encoding size is relatively large in order to accurately reflect the characteristics of the image as well as the improvement of the encoding efficiency. Hence, the maximum encoding size of the video data 310 and 320 having a resolution larger than that of the video data may be set to 64.

The maximum depth of the video data 310 is 2, and thus the coding unit of the video data 310 may include from the maximum coding unit having the size of the longer axis of 64 to the coding units of having longer axis sizes of 32 and 16 as the splits occurs twice and the depth becomes higher by two layers. In contrast, the maximum depth of the video data 330 is 1, and thus the coding units 335 of the video data may include from coding units having the longer axis size of 16 to coding units having the longer axis size of 8 as split occurs once and the depth becomes higher by one layer.

The maximum depth of the video data 320 is 3, and thus the coding unit 325 of the video data 320 may include from the maximum coding unit having the longer axis size of 64 to coding units having the longer axis sizes of 32, 16, and 8 as splits occur three times and the depth becomes higher by three layers. As the depth becomes higher, the capability of expression detailed information may be improved.

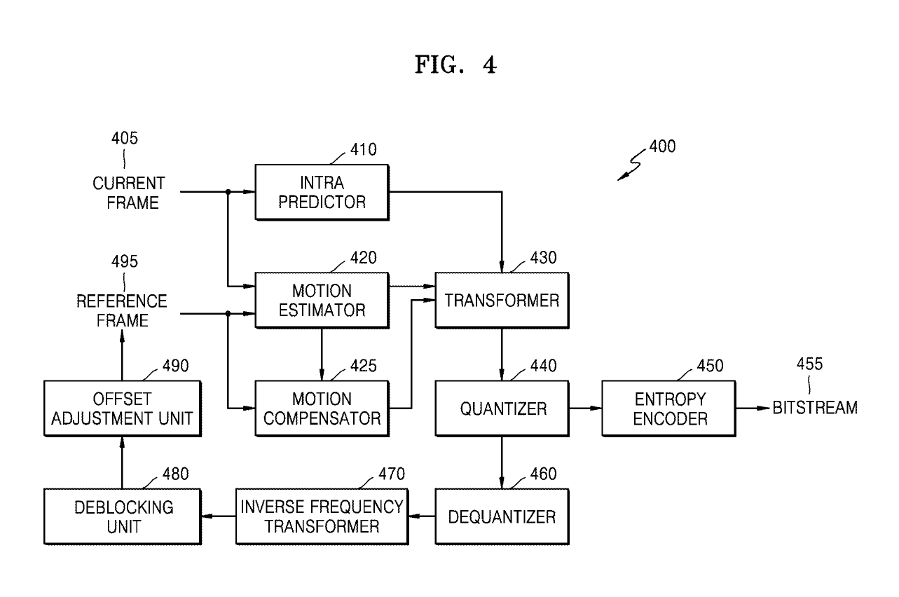

FIG. 4 is a block diagram of an image encoder based on an coding unit according to an embodiment of the present invention.

The image encoder 400 according to an embodiment of the present invention includes jobs which are performed encoding image data in the coding unit determiner 120 of the video encoding apparatus 100. That is, the intra predictor 410 performs intra prediction for the coding unit of the intra mode in the current frame 405, and the motion estimator 420 and the motion compensator 425 perform inter estimation and motion compensation by using the current frame 405 and the reference frame 495 of the inter mode.

Data, which are output from the intra predictor 410, the motion estimator 420, and the motion compensator 425, are output to the transformation coefficient via the transformer 430 and the quantizer 440. The quantized transformation coefficient is restored to the data of the space area through the dequantizer 460 and the inverse frequency transformer 470, and the data of the restored space area is post-processed via the deblocking unit 480 and the offset adjustment unit 490 so as to be outputted to the reference frame 495. The quantized transformation coefficient may be output to the bit stream via the entropy encoder 450.

In order to be applied to the video encoding apparatus 100 according to an embodiment of the present invention, all of the intra predictor 410, the motion estimator 420, the motion compensator 425, the transformer 430, the quantizer 440, the entropy encoder 450, the dequantizer 460, the inverse frequency transformer 470, the deblocking unit 480, and the offset adjustment unit 490, which are components of the image encoder 400, need to perform the job based on respective coding units from among coding units according to the tree structure in consideration of the maximum depth for respective maximum coding units.

In particular, the intra predictor 410, the motion estimator 420, and the motion compensator 425 determine the partition and prediction mode of respective coding units from among coding units according to the tree structure in consideration of the maximum size and the maximum depth of the current maximum coding unit, and the transformer 430 needs to determine the size of the transformation unit within the respective coding units from among coding units according to the tree structure.

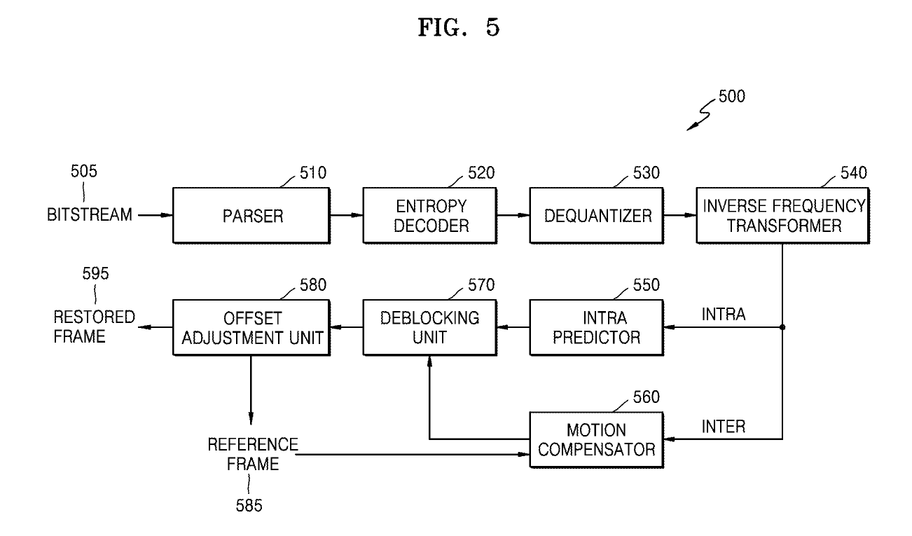

FIG. 5 is a block diagram of an image decoder based on an coding unit according to an embodiment of the present invention.

Information on the encoding which is needed for decoding and encoded image data which is the subject of decoding is parsed as the bit stream 505 passes through the parser 510. The encoded image data is output to the reverse quantized data via the decoder 520 and the dequantizer 530 via the entropy decoder 520 and the dequantizer 530, and image data of the space area is restored via the inverse frequency transformer 540.

With respect to image data of the space data, the intra predictor 550 performs intra prediction for the coding unit of the intra mode, and the motion compensator 560 performs motion compensation for the coding unit of the inter mode by using the reference frame 585.

The data of the space area, which has passed through the intra predictor 550 and the motion compensator 560, is post-processed via the deblocking unit 570 and the offset adjustment unit 580, so as to be output to the restored frame 595. Further, the data, which has been post-processed via the deblocking unit 570 and the offset adjustment unit 580, may be output as the reference frame 585.

In order to decode image data in the image data decoder 230 of the video decoding apparatus 200, operations after the parser 510 of the image decoder 500 according to an embodiment of the present invention may be performed.

In order to be applied to the video decoding apparatus 200 according to an embodiment of the present invention, all of the parser 510, the entropy decoder 520, the dequantizer 530, the inverse frequency transformer 540, the intra predictor 550, the motion compensator 560, the deblocking unit 570, and the offset adjustment unit 580 need to perform the job based on the coding units according to the tree structure for respective maximum coding units.

In particular, the motion compensator 560 determines the partition and prediction mode for respective coding units according to the tree structure, and the inverse frequency transformer 540 needs to determine the size of the transformation unit for respective coding units.

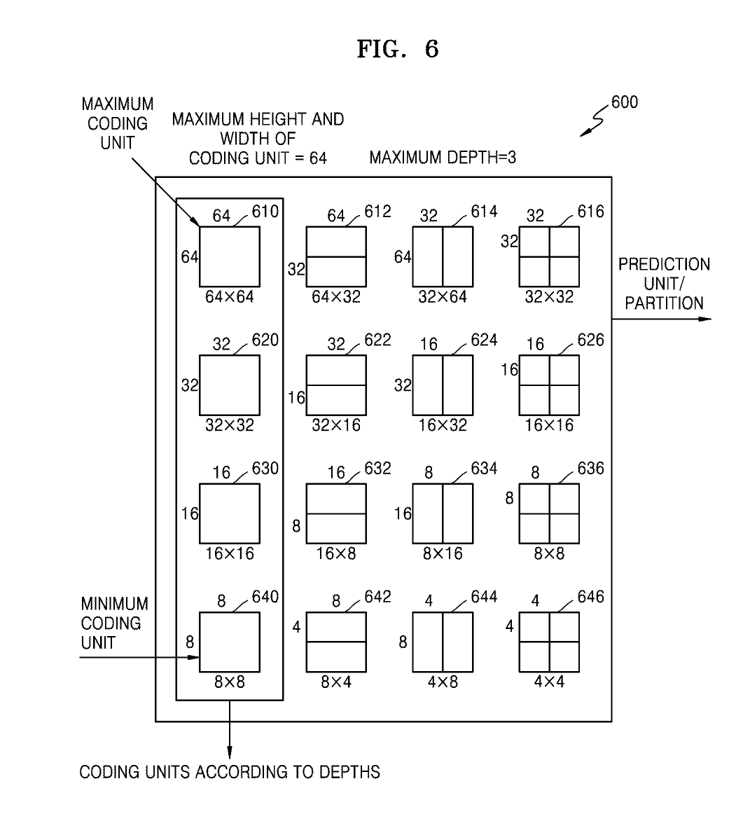

FIG. 6 illustrates a coding unit and partition according to depths according to an embodiment of the present invention.

The video encoding apparatus 100 according to an embodiment of the present invention and the video decoding apparatus 200 according to an embodiment of the present invention use hierarchical coding units in order to consider the image characteristics. The maximum height, width, and maximum depth of the coding units may be adaptively determined according to the characteristics of the image and may be variously set according to the user's requirements. The size of the coding units according to depths may be determined according to the maximum size of the predetermined coding unit.

The hierarchical structure 600 of the coding unit according to an embodiment of the present invention illustrates a case where the maximum height and width of the coding unit is 64 and the maximum depth is 3. At this time, the maximum depth indicates the total number of times of split from the maximum coding unit to the minimum coding unit. The depth becomes high along the vertical axis of the hierarchical structure 600 of the coding unit according to an embodiment of the present invention, and thus the height and the width of the coding unit for each depth are respectively split. Further, the prediction unit and partition, which become the basis of the prediction encoding of the coding unit according to depths, is illustrated along the horizontal axis of the hierarchical structure 600 of the coding unit.

That is, the coding unit 610 is the maximum coding unit in the hierarchical structure 600 of the coding unit and the depth is 9, and the size of the coding unit, i.e., height and width is 64×64. The depth becomes higher along the vertical axis, and there are the coding unit 620 of depth 1 32×32 size, the coding unit 630 of depth 2 of 16×16 size, and the coding unit 640 of depth 3 of 8×8 size. The coding unit 640 of depth 3 of 8×8 size is the minimum coding unit.

Prediction units and partitions of coding units are arranged along the horizontal axis for respective depths. That is, if the coding unit 610 of 64×64 size of depth 0 is the prediction unit, the prediction unit may be split into the partition 610 of 64×64 size included in the coding unit 610 of 64×64 size, partitions 612 of 64×32 size, partitions 614 of 32×64 size, and partitions 616 of 32×32 size.

Likewise, the prediction unit of the coding unit of 32×32 size of depth 1 may be split into the partition of 32×32 size included in the coding unit 620 of 32×32 size, partitions 622 of 32×16 size, partitions 624 of 16×32 size, and partitions 626 of 16×16 size.

The prediction unit of the coding unit 630 of 16×16 size of depth 2 may be split into the partition 630 of 16×16 size included in the coding unit 630 of 16×16 size, partitions 632 of 16×8 size, partitions 634 of 8×16 size, and partitions 636 of 8×8 size.

The prediction unit of the coding unit 640 of 8×8 size of depth 3 may be split into partition of 8×8 size included in the coding unit 640 of 8×8 size, partitions 642 of 8×4 size, partitions 644 of size 4×8 size, and partitions of 4×4 size.

Lastly, the coding unit 640 of 8×8 size of depth 3 is the minimum coding unit and the coding unit of the lowest depth.

The coding unit determiner 120 of the video encoding apparatus 100 according an embodiment of the present invention needs to perform encoding for respective ending units of respective depths included in the maximum coding unit 610 in order to determine the encoding depth of the maximum coding unit 610.

The number of coding units according to depths for including the data of the same range and size increases as the depth increases. For example, with respect to data included in one coding unit of depth 1, 4 coding units of depth 2 may be needed. Hence, in order to compare the encoding result of the same data according to depths, encoding needs to be performed respectively by using one coding unit of depth 1 and four coding units of depth 2.

For encoding for respective depths, the encoding may be performed for respective prediction units of coding units for respective depths along the horizontal axis of the hierarchical structure 600, and thereby the representative encoding error with the smallest encoding error may be selected. Further, the depth becomes high along the horizontal axis of the hierarchical structure 600 of the coding units, and the encoding may be performed for respective depths and the minimum encoding error may be searched by comparing the representative errors according to depths. The depth and partition, which has the minimum encoding error from among the maximum coding units 610, may be selected as the encoding depth and partition type of the maximum coding unit 610.

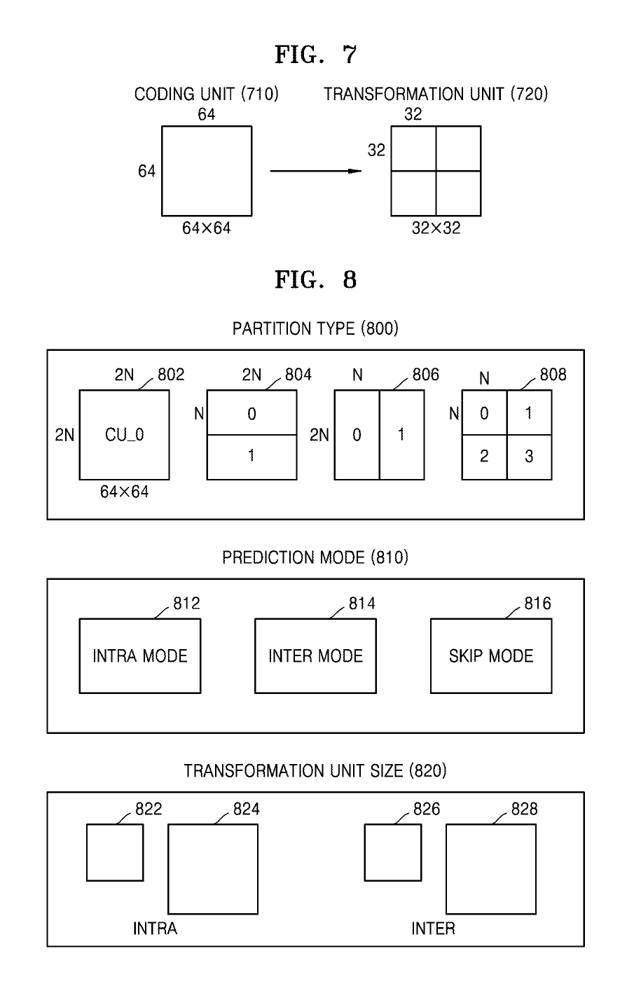

FIG. 7 illustrates the relation between the coding unit and the transformation unit according to an embodiment of the present invention.

The video encoding apparatus 100 according to an embodiment of the present invention or the video decoding apparatus 100 according to an embodiment of the present invention encodes or decodes an image in the coding unit of a size smaller than or the same as the size of the maximum coding unit for respective maximum coding units. The size of the transformation unit for transformation during the encoding process may be selected based on the data unit which is not greater than respective coding units.

For example, in the video encoding apparatus 100 according to an embodiment of the present invention or the video decoding apparatus 100 according to an embodiment of the present invention, when the current coding unit 710 has a 64×64 size, the transformation may be performed by using the transformation unit 720 of a 32×32 size.

Further, the data of the coding unit 710 of a 64×64 size may be respectively converted in transformation units of 32×32, 16×16, 8×8, and 4×4 sizes, and then the transformation unit with the smallest error compared with the original one may be selected.

FIG. 8 illustrates encoding information according to depths, according to an embodiment of the present invention.

The output unit 130 of the video encoding apparatus 100 according to an embodiment of the present invention may encode and transmit information 800 on partition type, information 810 on prediction mode, and information 820 on transformation unit size for respective coding units of respective encoding depths as information on the encoding mode.

Information on the partition type indicates information on the format of the partition that the prediction unit of the current coding unit has been split, as the data unit for the prediction encoding of the current coding unit. For example, the current coding unit CU_{—}0 of 2N×2N size may be split into one of the partition 802 of 2N×2N size, the partition 804 of 2N×N size, the partition 806 of N×2N size, and the partition 808 of N×N size. In this case, information 800 on the partition type of the current coding unit may be set to indicate one of the partition 802 of 2N×2N size, the partition 804 of 2N×N size, the partition 806 of N×2N size, and the partition 808 of N×N size.

The information on the prediction mode 810 indicates the prediction mode for respective partitions. For example, through the information 810 on the prediction mode, it may be set whether the prediction encoding of the partition indicated by the information 800 on the partition type is performed at one of the intra mode 812, the inter mode 814, and the skip mode 816.

Further, the information 820 on the transformation unit size indicates the transformation unit which becomes the basis of the transformation of the current coding unit. For example, the transformation unit may be one of the first intra transformation unit size 822, the second intra transformation unit size 824, the first inter transformation unit size 826, and the second inter transformation unit size 828.

The image data and encoding information extractor 210 of the video decoding apparatus 200 may extract information 800 on the partition type, information on the prediction mode 810, and information 820 on the transformation unit size for respective coding units for respective depths so as to be used in the decoding.

FIG. 9 illustrates the coding unit according to depths according to an embodiment of the present invention.

Split information may be used to indicate the change in depth. Split information indicates whether the coding unit of the current depth is to be split into coding units of the lower depth.

The prediction unit 910 for prediction encoding of the coding unit 900 of depth 0 and 2N_{—}0×2N_{—}0 size may include partition type 912 of 2N_{—}0×2N_{—}0 size, partition type 914 of 2N_{—}0×N_{—}0 size, partition type 916 of N_{—}0×2N_{—}0 size, and partition type 918 of N_{—}0×N_{—}0 size. Only partitions 912, 914, 916, and 918, in which the prediction unit has been split by the symmetric ratio, are illustrated, but as described above, the partition types are not limited thereto and may include an asymmetric partition, an arbitrary form of partition, and a geometric form of partition.

For each partition type, the prediction encoding needs to be repeatedly performed for one partition of 2N_{—}0×2N_{—}0 size, two partitions of 2N_{—}0×N_{—}0 size, two partitions of N_{—}0×2N_{—}0 size, and four partitions of N_{—}0×N_{—}0 size. With respect to partitions of 2N_{—}0×2N_{—}0 size, N_{—}0×2N_{—}0 size, 2N_{—}0×N_{—}0 size, and N_{—}0×N_{—}0 size, the prediction encoding may be performed at intra mode and inter mode. At the skip mode, the prediction encoding may be performed for only the partition of 2N_{—}0×2N_{—}0.

If the encoding error by one of partitions types 912, 914, and 916 of 2N_{—}0×2N_{—}0 size, 2N_{—}0×N_{—}0 size, and N_{—}0×2N_{—}0 size is the smallest, the partition by a further lower depth is not needed.

If the encoding error by the partition 918 of N_{—}0×N_{—}0 size is the smallest, depth 0 is changed to 1, split is performed (920), and encoding is repeatedly performed for coding units 930 of the partition type of depth 2 and N_{—}0×N_{—}0 size so as to search for the minimum encoding error.

The prediction unit 944 for the prediction encoding of the coding unit 930 of depth 1 and 2N_{—}1×2N_{—}1 (=N_{—}0×N_{—}0) may include the partition type 942 of 2N_{—}1×2N_{—}1 size, the partition type 944 of 2N_{—}1×N_{—}1 size, the partition type 946 of N_{—}1×2N_{—}1 size, and partition type 948 of N_{—}1×N_{—}1 size.

Further, if the encoding error by the partition type 948 of N_{—}1×N_{—}1 size is the smallest, depth 1 is changed to depth 2, split is performed 950, and encoding is repeatedly performed for coding units 960 of depth 2 and N_{—}2×N_{—}2 size so as to search for the minimum error.

If the maximum depth is d, the coding unit according to depths is set until the time when the depth is d−1 and the split information may be set until the time when the depth is d−2. That is, if the split 970 is started from depth d−2 and the encoding is performed even up to depth d−1, the prediction unit 990 for the prediction encoding of the coding unit 980 of depth d−1 and 2N_(d−1)×2N_(d−1) size may include the partition type 992 of 2N_(d−1)×2N_(d−1) size, the partition type 994 of 2N_(d−1)×N_(d−1) size, the partition type 996 of N_(d−1)×2N_(d−1) size, and the partition type 998 of N_(d−1)×N_(d−1) size.

The encoding through prediction encoding is performed for one partition of 2N_(d−1)×2N_(d−1) size, two partitions of 2N_(d−1)×N_(d−1) size, two partitions of N_(d−1)×2N_(d−1) size, and four partitions of N_(d−1)×N_(d−1) size from among the partition types so that a partition type with the minimum encoding error may be searched.

Even though the encoding error by the partition type 998 of N_(d−1)×N_(d−1) size is the smallest, the maximum depth is d, and thus the coding unit CU_(d−1) of depth d−1 does not go through the split process of the lower depth any more. Further, the encoding depth for the current maximum coding unit 900 may be determined as d−1, and the partition type may be determined as N_(d−1)×N_(d−1). Further, the maximum depth is d, and thus the split information for the coding unit 952 of depth d−1 is not set.

The data unit 999 may be referred to as the minimum unit for the current maximum coding unit. The minimum unit according to an embodiment of the present invention may be the data unit of a square of which the size is ¼ of the minimum coding unit which is the lowest encoding depth. Through such a repeated encoding process, the video encoding apparatus 100 according to an embodiment of the present invention compares the encoding error according to depths of the coding unit 900 so as to select the depth where the smallest encoding error occurs so as to determine the encoding depth, and the partition type and prediction mode may be determined as the encoding mode of the encoding depth.

The minimum encoding error is compared by all depths of depths 0, 1, . . . , d−1, and d so that the depth with the smallest error may be selected and determined as the encoding depth. The encoding depth, the partition type of the prediction unit, and the prediction mode may be encoded as information about the encoding mode so as then to be transmitted. Further, the coding unit needs to be split from depth 0 to the encoding depth, and thus only the split information of the encoding depth is set to 0, and the split information for respective depths except the encoding depth needs to be set to 1.

The image data and encoding information extractor 220 of the video decoding apparatus 200 according to an embodiment of the present invention may be used in extracting information on the encoding depth and prediction unit and decoding the coding unit 912. The video decoding apparatus 200 according to an embodiment of the present invention may recognize the depth of which the split information is 0 by using the split information for respective depths and may use information on the decoding mode for the depth in the decoding.

FIGS. 10, 11, and 12 illustrate the relation between the coding unit, the prediction unit, and the transformation unit, according to an embodiment of the present invention.

The coding units 1010 are coding units for respective encoding depths which have been determined by the video encoding apparatus 100 according to an embodiment of the present invention. The prediction units 1060 are partitions of the prediction units of the coding unit for respective encoding depths from among coding units 1010, and the transformation units 1070 are transformation units of the coding units for respective encoding depths.

With respect to the coding units 1010 for respective depths, if the depth of the maximum coding unit is 0, the depth of the coding units 1012 and 1054 is 1, the depth of the coding units 1014, 1016, 1018, 1028, 1050, and 1052 is 2, the depth of the coding units 1020, 1022, 1024, 1026, 1030, 1032, and 1048 is 3, and the depth of the coding units 1040, 1042, 1044, and 1046 is 4.

Among prediction units 1060, some partitions 1014, 1016, 1022, 1032, 1048, 1050, 1052, and 1054 are in the form of splits of the coding unit. That is, partitions 1014, 1022, 1050, and 1054 are the partition type of 2N×N, partitions 1016, 1048, and 1052 are the partition type of N×2N, and the partition 1032 is the partition type of N×N. The partitions and prediction units of the coding units 1010 for respective depths are the same as or smaller than the respective coding units.

With respect to mage data of some 1052 of transformation units 1070, the transformation or reverse transformation is performed in data units of sizes smaller than those of the coding units. Further, the transformation units 1014, 1016, 1022, 1032, 1048, 1050, 1052, and 1054 are data units of different sizes or forms if compared with the prediction units and partitions from among the prediction units 1060. That is, the video encoding apparatus 100 according to an embodiment of the present invention and the video decoding apparatus 200 according to an embodiment of the present invention may perform the intra prediction/motion estimation/motion compensation job, and transformation/reverse transformation job for the same coding unit, based on respective data units.

As such, the encoding is recursively performed for respective coding units of the hierarchical structures for respective areas for respective coding units, and thereby the optimal coding unit is determined. Hence, the coding units according to the recursive tree structure may be formed. The encoding information may include split information, partition type information, prediction mode information, and transformation unit size information for coding units. Table 1 below shows an example which may be set in the video encoding apparatus 100 according to an embodiment of the present invention and the video decoding apparatus 200 according to an embodiment of the present invention.

TABLE 1

| Split info 0 (encoding about the coding unit of 2N × 2N size of | | | | | |
|---|---|---|---|---|---|
| current depth d) | | | | | |
| | Partition type | | Transformation unit size | | |
| | Symmetric | Asymmetric | Transformation | Transformation unit | |
| Prediction | partition | partition | unit split | split info | |
| mode | type | type | info 0 | 1 | Split info 1 |
| Intra | 2N × 2N | 2N × nU | 2N × 2N | N × N | Repeated |
| Inter | 2N × N | 2N × nD | | (symmetric | encoding for |
| Skip (only | N × 2N | nL × 2N | | partition type) | respective |
| 2N × 2N) | N × N | nR × 2N | | N/2 × N/2 | coding units |
| | | | | (asymmetric | of lower depth |
| | | | | partition type) | d + 1 |

The output unit 130 of the video encoding apparatus 100 according to an embodiment of the present invention may output encoding information for coding units according to the tree structure and the encoding information extractor 220 of the video decoding apparatus 200 according to an embodiment of the present invention may extract encoding information for coding units according to the tree structure from the received bit stream.

The split information indicates whether the current coding unit is split into coding units of the lower depth. If split information of current depth d is 0, the depth, at which the current coding unit is not further split into the lower coding units, is the encoding depth, and thus the partition type information, prediction mode, and transformation unit size information may be defined for the encoding depth. When one more split needs to be made according to the split information, the encoding needs to be performed independently for respective coding units of the 4 split lower depths.

The prediction mode may be indicated as one of the intra mode, inter mode, and skip mode. The intra mode and the inter mode may be defined in all partition types, and the skip mode may be defined only in partition type 2N×2N.

The partition type information may indicate symmetric partition types 2N×2N, 2N×N, N×2N, and N×N, in which the height or width of the prediction unit has been split in the symmetric ratio, and asymmetric partition types 2N×nU, 2N×nD, nL×2N, and nR×2N, in which the height or width of the prediction unit has been split in the asymmetric ratio. Asymmetric partition types 2N×nU and 2N×nD indicate a form in which heights of the respective types have been split by 1:3 and 3:1, and asymmetric partition types nL×2N and nR×2N indicate a form in which widths of the respective types have been split by 1:3 and 3:1.

The transformation unit size may be set as two kinds of sizes in the intra mode and may be set as two kinds of sizes in the inter mode. That is, if transformation unit split information is 0, the size of the transformation unit is set to 2N×2N which is the size of the current coding unit. If the transformation unit split information is 1, the transformation unit of the size of the split of the current coding unit may be set. Further, if the partition type on the current coding unit of which the size is 2N×2N is the symmetric partition type, the size of the transformation unit may be set to N×N, and if the partition type is the asymmetric partition type, the size may be set to N/2×N/2.

The encoding information of coding units according to the tree structure according to an embodiment of the present invention may be allocated to at least one of the coding unit of the coding unit, the prediction unit, and the minimum unit of the encoding depth. The coding unit of the encoding depth may include one or more of the prediction unit and the minimum unit which hold the same encoding information.

Hence, if encoding information, which adjacent data units hold, is checked, it may be checked whether included in the coding unit of the same encoding depth. Further, if the encoding information held by the data unit is used, the coding unit of the corresponding encoding depth may be checked, and thus the distribution of the encoding depths within the maximum coding unit may be inferred.

Hence, in this case, if the current coding unit may not be predicted with reference to the surrounding data units, the encoding information within the data units within the coding units according to depths which are adjacent to the current coding units may be directly referred to so as to be used.

As another embodiment, if the prediction encoding of the current coding unit is performed with reference to the surrounding coding unit, the surrounding coding unit may be referred to as the data adjacent to the current coding unit is searched within the coding units according to depths by using the encoding information of the adjacent coding units according to depths.

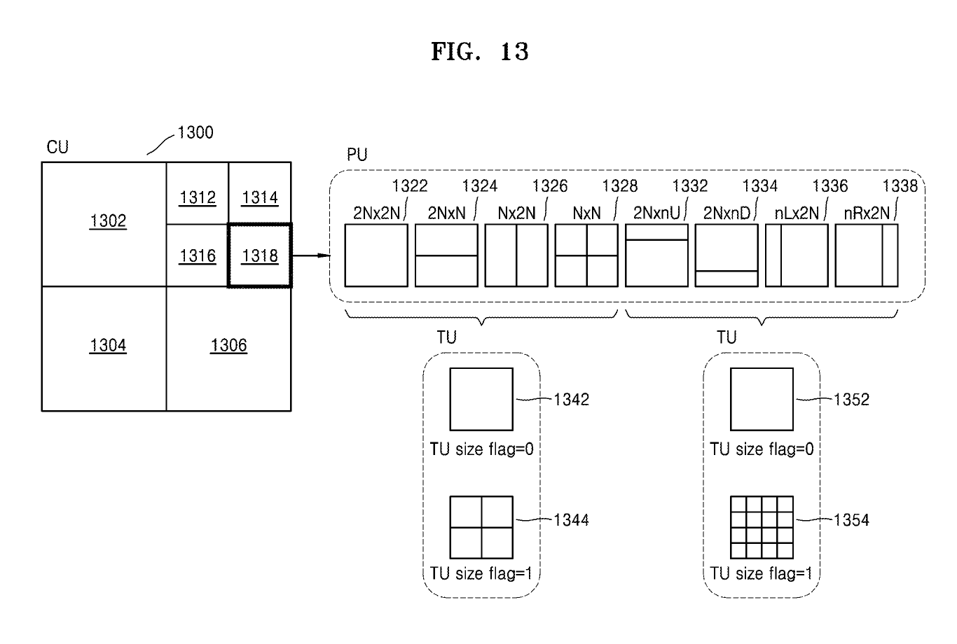

FIG. 13 illustrates the relation between the coding unit, the prediction unit, and the transformation unit according to encoding mode information of Table 1.

The maximum coding unit 1300 includes coding units 1302, 1304, 1306, 1312, 1314, 1316, and 1318 of encoding depths. Here, one coding unit 1318 is the coding unit of the encoding depth, and thus the split information may be set to 0. The partition type information of the coding unit 1318 of 2N×2N size may be set to one of partition types 2N×2N 1322, 2N×N 1324, N×2N 1326, N×N 1328, 2N×nU 1332, 2N×nD 1334, nL×2N 1336, and nR×2N 1338.

Transformation unit split information (TU size flag) is a kind of a transformation index and the size of the transformation unit corresponding to the transformation index may be changed according to the prediction unit type or partition type of the coding unit.

For example, when the partition type information is set as one of symmetric partition types 2N×2N 1322, 2N×N 1324, N×2N 1326, and N×N 1328, if the transformation unit split information is 0, the transformation unit 1342 of 2N×2N size is set, and if the transformation unit split information is 1, the transformation unit 1344 of N×N size may be set.

When the partition type information is set as one of asymmetric partition types 2N×nU 1332, 2N×nD 1334, nL×2N 1336, and nR×2N 1338, if the transformation unit split information (TU size flag) is 0, the transformation unit 1352 of 2N×2N size is set, and if the transformation unit split information is 1, the transformation unit 1354 of N/2×N/2 size may be set.

The transformation unit split information (TU size flag), which has been described with reference to FIG. 13, is a flag having a value of 0 or 1, but the transformation unit split information according to an embodiment of the present invention is not limited to the flag of 1 bit, and the transformation unit may be hierarchically split as the split information may increase from 0 to 1, 2, 3, etc. The transformation unit split information may be used an embodiment of the transformation index.

In this case, if the transformation unit split information according to an embodiment of the present invention is used with the maximum size of the transformation unit and the minimum size of the transformation unit, the size of the actually used transformation unit may be expressed. The video encoding apparatus 100 according to an embodiment of the present invention may encode the maximum transformation unit size information, the minimum transformation unit size information, and the maximum transformation unit split information. The encoded maximum transformation unit size information, the minimum transformation unit size information, and the maximum transformation unit split information may be inserted into SPS. The video decoding apparatus 200 according to an embodiment of the present invention may use the maximum transformation unit size information, the minimum transformation unit size information, and the maximum transformation unit split information in the video decoding.

For example, (a) if the size of the current coding unit is 64×64 and the maximum transformation unit size is 32×32, (a−1) when the transformation unit split information is 0, the transformation unit size may be set to 32×32, (a−2) when the transformation unit split information is 1, the transformation unit size may be set to 16×16, and (a−3) when the transformation unit split information is 2, the transformation unit size may be set to 8×8.

As another example, (b) if the current coding unit size is 32×32 and the minimum transformation unit size is 32×32, (b−1) when the transformation unit split information is 9, the transformation unit size may be set to 32×32, and because the transformation unit size cannot be smaller than 32×32, further transformation unit split information cannot be set.

As another example, (c) if the current coding unit size is 64×64 and the maximum transformation unit split information is 1, the transformation unit split information may be 0 or 1 and other transformation unit split information cannot be set.

Hence, when the maximum transformation unit split information is defined as “MaxTransformSizeIndex”, the minimum transformation unit size is defined as “MinTransformSize”, and the transformation unit size when the transformation unit split information is 0 is defined as “RootTuSize”, the minimum transformation unit size “CurrMinTuSize”, which is possible in the current coding unit, may be defined as shown in equation 1 below.

CurrMinTuSize=max(MinTransformSize,RootTuSize/(2̂MaxTransformSizeIndex)) (1)

By comparing with the minimum transformation unit size “CurrMinTuSize” which is possible in the current coding unit, the “RootTuSize”, which is the transformation unit size when the transformation unit split information is 0, may indicate the maximum transformation unit size which may be adaptable according to the system. That is, according to equation 1, “RootTuSize/(2̂MaxTransformSizeIndex)” is the transformation unit size which is the size after splitting the transformation unit size “RootTuSize” by the number of times corresponding to the maximum transformation unit split information and the “MinTransformSize” is the minimum transformation unit size, and thus a smaller value among them may be “CurrMinTuSize” which is the minimum transformation unit size which is possible in the current coding unit.

The maximum transformation unit size RootTuSize according to an embodiment of the present invention may be changed according to the prediction mode.

For example, if the current prediction mode is the inter mode, RooTuSize may be determined according to equation 2 below. In equation 2, “MaxTransformSize” indicates the maximum transformation unit size, and “PUSize” indicates the current prediction unit size.

RootTuSize=min(MaxTransformSize,PUSize) (2)

That is, if the current prediction mode is the inter mode, “RootTuSize”, which is the transformation unit size when the transformation unit split information is 0, may be set to a smaller value among the maximum transformation unit size and the current prediction unit size.

If the prediction mode of the current partition unit is the intra mode, “RootTuSize” may be determined according to equation 3 below. “PartitionSize” indicates the size of the current partition unit.

RootTuSize=min(MaxTransformSize,PartitionSize) (3)

That is, if the current prediction mode is the intra mode, “RootTuSize”, which is the transformation unit size when the transformation unit split information is 0, may be set to a smaller value among the maximum transformation unit size and the current partition unit size.

Only, “RootTuSize”, which is changed according to the prediction mode of the partition unit and is the current maximum transformation unit size according to an embodiment of the present invention, is only an embodiment, and the factor for determining the current maximum transformation unit size is not limited to the embodiment.

The maximum coding unit including coding units of the tree structure which has been described above with reference to FIGS. 1 to 13 is also referred to as a coding block tree, a block tree, a root block tree, a coding tree, a coding root, a tree trunk, etc.

As described above, the video encoding apparatus 100 and the video decoding apparatus 200 according to an embodiment of the present invention splits the maximum coding unit in an coding unit which is the same as or smaller than the maximum coding unit so as to perform encoding and decoding. In order to improve the process speed of the decoding process of an image, the image decoding process may be performed in parallel. However, when an arbitrary picture refers to another picture, the arbitrary picture cannot be decoded before the decoding process of the referenced picture is completed. The pictures, which can be decoded in parallel, need to be pictures which are not referenced to each other. Further, when pictures, which may be decoded in parallel, are predicted with reference to other reference pictures, the decoding of reference pictures at the point of time of parallel decoding needs to be completed. Hence, in order to determine pictures, in which parallel decoding is possible, the order of decoding pictures and the reference relation between pictures need to be determined. In the video decoding scheme for the parallel process according to an embodiment of the present invention, reference relation information included in the group of picture (GOP) is generated based on the encoding order and reference dependency of pictures, and the reference relation information is included in a predetermined data unit so as to be transmitted. In the video decoding scheme according to an embodiment of the present invention, the decoding order and reference dependency between pictures included in the GOP are determined based on the reference relation information included in a predetermined data unit, and pictures, which may be processed in parallel, are determined based on the decoding order and reference dependency. Further, in the video decoding scheme according to an embodiment of the present invention, pictures, which may be processed in parallel, are decoded in parallel.

Hereinafter, the video encoding/decoding scheme for the parallel process will be described with reference to FIGS. 14 to 23. The decoding order and the encoding order indicate the order of processing a picture on the basis of the decoding side and the encoding side, respectively, and the encoding order of a picture is the same as the decoding order. Hence, when describing embodiments of the present invention below, the encoding order may mean the decoding order, and the decoding order may also mean the encoding order.

FIG. 14 is a block diagram of a video encoding apparatus for a parallel process according to an embodiment of the present invention.

Referring to FIG. 14, a video encoding apparatus 1400 includes an image encoder 1410 and an output unit 1420. The image encoder 1410 performs prediction encoding for each picture which forms a video sequence by using coding units according to the tree structure as in the image encoder 400 of FIG. 4. The image encoder 1410 encodes pictures through inter prediction and intra prediction so as to output information on the residual data, motion vector, and prediction mode. In particular, the image encoder 1410 according to an embodiment of the present invention performs inter prediction and intra prediction for pictures included in the GOP and determines the encoding order and reference dependency between pictures included in the GOP. The reference dependency indicates the reference relation between pictures included in the GOP and may be a reference picture set (RPS). The RPS indicates picture order count (POC) information of the reference picture. For example, when RPS of an arbitrary B picture is [0, 2], B picture uses the picture of which the POC is 0 and the picture of which the POC is 2 as the reference pictures. Hence, B picture is a picture which is dependent on the picture of which the poc is 0 and the picture of which the POC is 2. B picture cannot be decoded until the decoding process of the picture of which the POC is 0 and the picture of which the POC is 2 is completed.

The output unit 1420 generates and outputs NAL unit including encoded video data and additional information. In particular, the output unit 1420 according to an embodiment of the present invention generates reference relation information based on the encoding order and reference dependency between pictures included in the GOP and generates NAL units including the generated reference relation information. The order and reference dependency of pictures, which are decoded in the hierarchical picture structure, may be indicated by using the data structure such as the deterministic finite automate (DFA). For example, the output unit 1620 according to an embodiment of the present invention may use a reference dependency tree (RDT), which indicates the encoding order and reference dependency between pictures within the GOP, as the reference relation information.

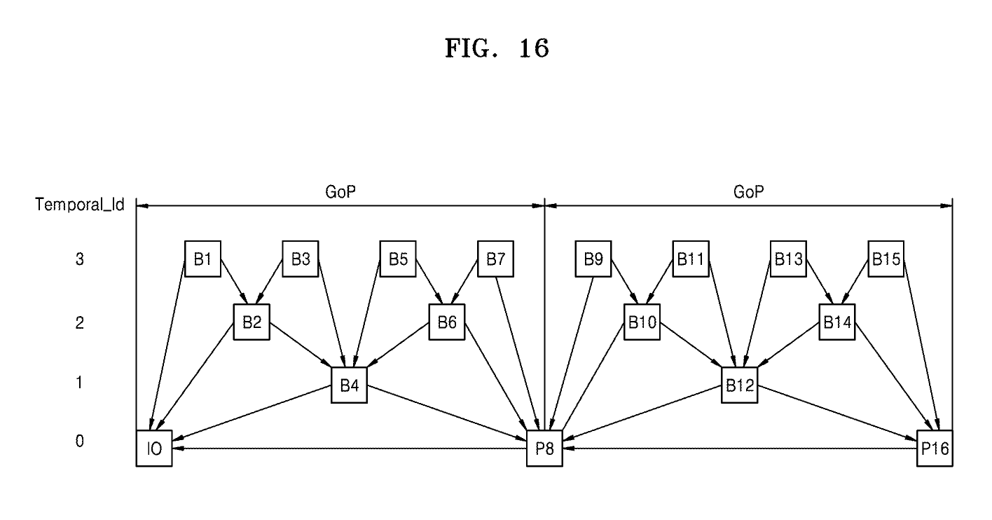

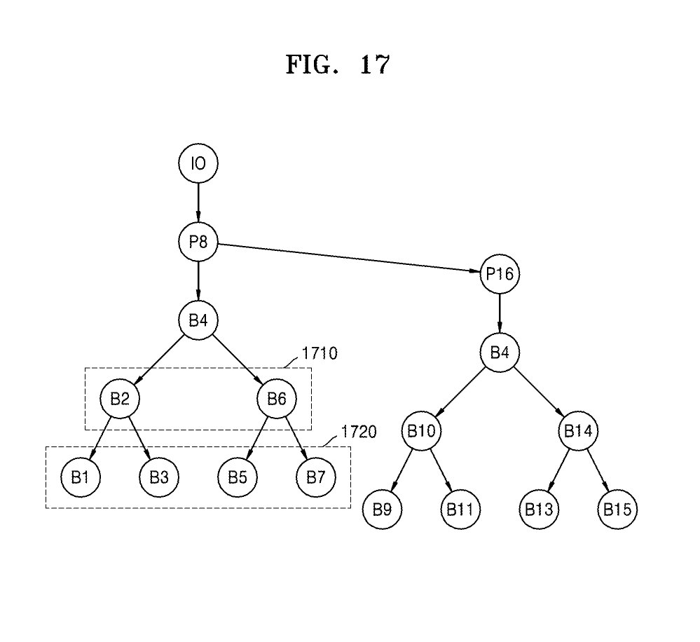

The RDT may be generated by positioning the picture referred to by the picture within the GOP in the parent node and positioning the picture which refers to the picture of the parent node in the child node on the basis of the encoding order and reference dependency. When parallel processing of a plurality of pictures which refer to the picture of the parent node is possible, RDT is formed by allowing a plurality of pictures to be included in the child node of the same layer. If the picture, which is composed of I slice which does not refer to other pictures from among pictures included in the GOP, may form RDT to be positioned in the uppermost root node. The specific RDT generation scheme will be described later with reference to FIGS. 16 and 17.

The output unit 1420 includes reference relation information in the NAL unit so as to be outputted. The reference relation information may be included in supplemental enhancement information (SEI) message including additional information from among NAL units.

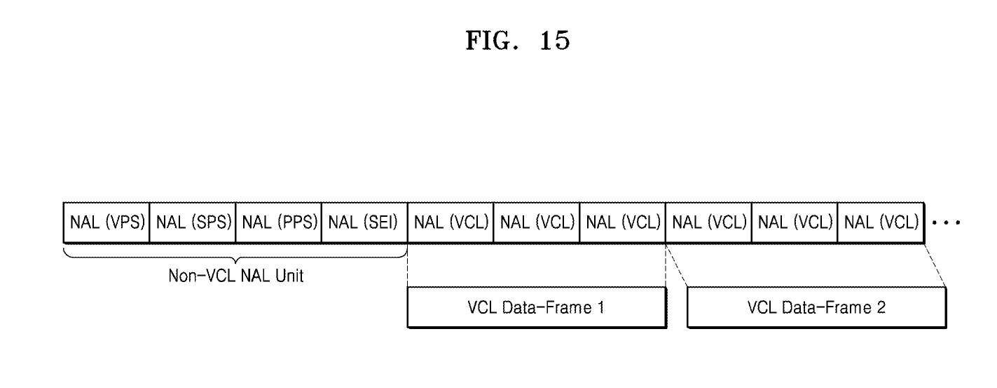

FIG. 15 illustrates the type of NAL unit according to an embodiment of the present invention.

The video encoding/decoding process may be classified as the encoding/decoding process in a video encoding layer (VCL) which handles the video encoding process itself and an encoding/decoding process in a network abstraction layer which generates or receives additional information such as image data and the parameter set which are encoded between VCL and the lower system which transmits and stores encoded image data, as a bit stream according to a predetermined format. The encoding data about the encoded image of VCL are mapped in VCL NAL units, and the additional information of the parameter set for the decoding of the encoding data is mapped in non-VCL NAL units.

Referring to FIG. 15, the non-VCL NAL unit may include a video parameter set (VPS), a sequence parameter set (SPS), and a picture parameter set (PPS) which contain parameter information used in the video encoding apparatus 1400, and SEI which contains additional information which is needed in the image decoding process. The VCL NAL unit includes information on encoded image data.

NAL unit header may have the length of a total of 2 bytes. The NAL unit header is a bit for identification of NAL unit and includes forbidden_zero_bit having the value of 0, an identifier indicating the type of NAL unit (nal unit type), an area reserved for future use (reserved_zero_{—}6 bits), and a temporal identifier (temporal_id). The identifier (nal unit type) and the area reserved for future use (reserved_zero_{—}6 bits) are formed respectively of 6 bits, and the temporal identifier (temporal_id) may be composed of 3 bits. The type of information included in NAL unit is distinguished according to the value of the nal_unit_type.

For example, instantaneous decoding refresh (IDR) picture, clean random access (CRA) picture, SPS, PSS, SEI, adaptation parameter set (APS), NAL unit reserved to be used for future extension, undefined NAL unit, etc. may be classified according to the nal_unit_type. Table 2 is an example indicating the types of NAL units according to the value of the nal_unit_type. However, the types of NAL units according to the nal_unit_type are not limited to the examples of Table 2.

TABLE 2

| nal_unit_type | Name of nal_unit_type |
|---|---|
| 0, | TRAIL_N |
| 1 | TRAIL_R |
| 2, | TSA_N |
| 3 | TSA_R |
| 4, | STSA_N |
| 5 | STSA_R |
| 6, | RADL_N |
| 7 | RADL_R |
| 8, | RASL_N |
| 9 | RASL_R |
| 10, | RSV_VCL_N10 |
| 12, | RSV_VCL_N12 |
| 14 | RSV_VCL_N14 |
| 11, | RSV_VCL_R11 |
| 13, | RSV_VCL_R13 |
| 15 | RSV_VCL_R15 |
| 16, | BLA_W_LP |
| 17, | BLA_W_RADL |
| 18 | BLA_N_LP |
| 19, | IDR_W_RADL |
| 20 | IDR_N_LP |
| 21 | CRA_NUT |
| 22, | RSV_IRAP_VCL22 |
| 23 | RSV_IRAP_VCL23 |
| 24 . . . 31 | RSV_VCL24 . . . RSV_VCL31 |
| 32 | VPS_NUT |
| 33 | SPS_NUT |
| 34 | PPS_NUT |
| 35 | AUD_NUT |
| 36 | EOS_NUT |
| 37 | EOB_NUT |
| 38 | FD_NUT |
| 39 | PREFIX_SEI_NUT |
| 40 | SUFFIX_SEI_NUT |

FIG. 16 illustrates a hierarchical GOP structure according to an embodiment of the present invention, FIG. 17 illustrates a reference dependency tree (RDT) for pictures included in the hierarchical GOP structure of FIG. 16. The hierarchical GOP structure of FIG. 16 is also referred to as hierarchical B picture structure.

Referring to FIG. 16, it is assumed that in the hierarchical GOP structure, pictures of the lower temporal level are limited not to refer to pictures of the upper temporal level. Further, the arrow direction indicates the reference direction. For example, in FIG. 16, P8 picture refers to I0 picture, and B4 picture is predicted with reference to I0 picture and P8 picture.

As described above, RDT may be generated by positioning the picture referred to by the picture within GOP in the patent node and positioning the picture referring to the picture of the parent node in the child node on the basis of the encoding order and reference dependency. The picture, which is positioned in the child node, is a picture which is predicted by referring to the parent node and another picture which is positioned in the upper level of the parent node. When the parallel process of a plurality of pictures referring to the picture of the parent node is possible, RDT is formed by allowing a plurality of pictures to be included in the child node of the same layer.

Referring to FIGS. 16 and 17, I0, which is IDR picture which is encoded for the first time in the GOP, is positioned in the uppermost node. P8 picture, which is encoded after I0 with reference to I0, is encoded next, and is positioned in the child node of I0. B4, which refers to I0 and P8, is positioned in the child node of P8. In FIG. 16, B2 refers to I0 and B4, B6 refers to B4 and P8, and both B2 and B6 correspond to the picture which may be decoded in parallel if B4 is decoded. Hence, Both B2 and B6 are positioned in the child node of B4. Similarly, B1 refers to I0 and B2, and B3 refers to B2 and B4. Further, B5 refers to B4 and B6, and B7 refers to B6 and P8. Hence, B1 and B3 are positioned in the child node of B2, and B5 and B7 are positioned in the child node of B6. RDT may be formed similarly for the GOP after the first GOP. Only, P8 of the first GOP corresponds to the first-encoded (or decoded) reference picture of P16 of the second GOP, and thus P16 is positioned in the child node of P8. If P16 refers to I0, not P8, both P8 and P16 have the same level as the child node of I0.

In FIG. 17, if the RDT for the GOP is formed, child nodes positioned at the same level are referenced to each other and thus correspond to the pictures which allow a parallel process. For example, in FIGS. 17, B2 and B6 1710 are pictures which may be processed in parallel after the encoding (or decoding) for B4 is completed. Further, B1, B3, B5, and B7 1720 are pictures which may be processed in parallel after the process for B2 and B6 1710 is completed.

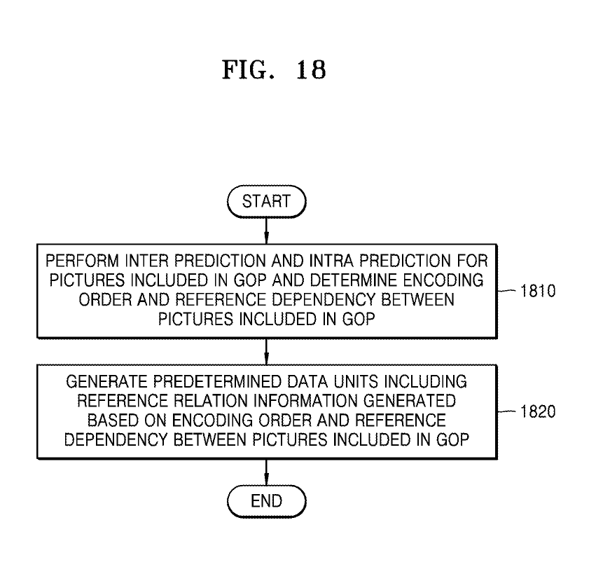

FIG. 18 is a flowchart illustrating a video encoding method for a parallel process, according to an embodiment of the present invention.

Referring to FIG. 18, in operation 1810, the image encoder 1410 performs inter prediction and intra prediction for pictures included in the GOP and determines encoding order and reference dependency between pictures included in the GOP.

In operation 1820, the output unit 1420 generates reference relation information based on the encoding order and reference dependency between pictures included in the GOP and generates NAL unit including the generated reference relation information. As described above, RDT, which indicates the encoding order and reference dependency between pictures within the GOP, may be used as the reference relation information.

Further, the output unit 1420 may include reference relation information in NAL unit including the supplemental enhancement information (SEI) message so as to be transmitted to the video decoding apparatus.

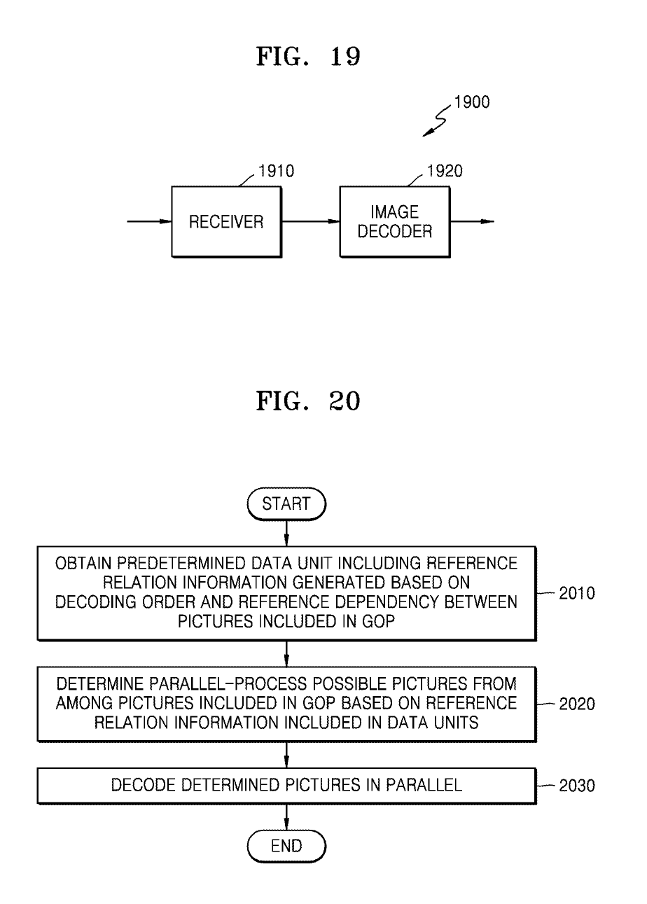

FIG. 19 is a block diagram of a video decoding apparatus for a parallel process according to an embodiment of the present invention.

Referring to FIG. 19, the video decoding apparatus 1900 includes a receiver 1910 and an image decoder 1920. The receiver 1910 obtains NAL units including reference relation information based on the decoding order and reference dependency between pictures included in the GOP. As described above, RDT may be used as the reference relation information, and RDT may be obtained through NAL units including SEI message.

The image decoder 1920 determines pictures which may be processed in parallel from among pictures included in the GOP based on the RDT included in the SEI message. As illustrated in FIG. 17, pictures, which are positioned on the same level among nodes positioned in the RDT, are pictures which allow a parallel process which is not referenced to each other. The image decoder 1920 may decode parallel-process possible pictures in parallel. The image decoder 1920 may perform decoding based on the decoder of the tree structure as in the image decoder 400 of FIG. 5.

FIG. 20 is a flowchart illustrating a video decoding method for a parallel process according to an embodiment of the present invention.

Referring to FIG. 20, in operation 2010, the receiver 1910 obtains NAL units including reference relation information which is generated based on the decoding order and reference dependency between pictures included in the GOP. As described above, the reference relation information may be a data structure such as RDT.

In operation 2020, the image decoder 2020 determines pictures which allow a parallel process from among pictures included in the GOP, based on the reference relation information included in SEI NAL units. As described above, the pictures, which are positioned on the same level from among nodes positioned in the RDT, are pictures which are not referenced to each other and thus they are parallel-process possible pictures.

In operation 2030, the image decoder 1920 improves the decoding process speed by decoding parallel-process possible pictures in parallel. Image data and additional information, which are needed in a parallel process, may be obtained from VPS, SPS, PPS, and VCL NAL units.

According to some embodiments of the present invention, parallel-process possible pictures may be determined in the decoding side by transmitting reference relation information between pictures included in the GOP through the SEI message. Hence, according to some embodiments of the present invention, parallel decoding of pictures without mutual dependency in the video decoding process is possible.

Further, the above-described parallel process encoding or decoding operation may be implemented through a multi-core system or multi-threading. The multi-threading is for allowing a parallel process within a program, and the parallel process is possible even in a single process.

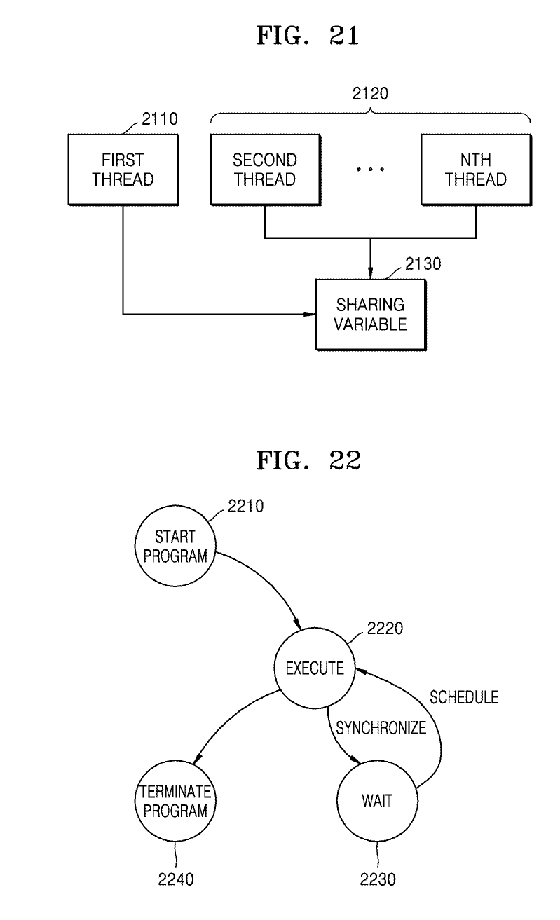

FIG. 21 illustrates a multi-threading program for a parallel process according to an embodiment of the present invention.

The parallel process encoding/decoding operation according to an embodiment of the present invention may implement a parallel process which does not need a separate synchronization process by analyzing reference dependency between respective pictures, splitting the encoding/decoding process of respective pictures into a plurality of individual tasks, and processing respective tasks through a dependency free execution model.

Referring to FIG. 21, the encoding/decoding process of each picture in the multi-threading program may be split into n threads 2110 and 2120. The thread indicates the unit of a flow which is executed in a process. The multi-threads may share the sharing variable 2130 within the sharing memory. Generally, in a multi-threading program, if a sharing variable 2130 is used, the synchronization between threads has been implemented by using a lock or semaphore or through a separate module such as a scheduler. For example, when the third thread 2110 uses a sharing variable 2130, other threads 2120 are in a waiting state until the use of the lock or semaphore related with the sharing variable 2130 by the first thread 2110 finishes, and the execution is stopped by the scheduler.

FIG. 22 illustrates a thread execution process in a multi-threading program which uses a lock or semaphore.

Referring to FIG. 22, the thread maintains the continuous execution 2220 of the program until the state becomes the waiting state 2230 by synchronization after the program start 2210. If the state becomes the waiting state by synchronization, the scheduler changes the thread to the waiting state 2230, and the thread is in the waiting state 2230 until the lock or semaphore becomes available. If the lock or semaphore becomes available and the scheduler is executed, the scheduler re-changes the thread to an operable state, and if the thread comes to be in an executable state again according to the scheduling policy, the ownership of the processor is deliver to the thread so that the program may be executed 2220. Likewise, in a multi-threading program which uses a lock or semaphore, a separate scheduler is needed, and a waiting time is lengthened until the thread is re-performed by the scheduler.

Such a waiting time issue may be resolved through a spin-wait scheme. The spin-wait scheme is a scheme in which the change of the sharing variable is continually checked and the execution state of the thread is maintained until the sharing variable is changed. Such a spin-wait scheme may improve the synchronization reactivity, i.e., speed, but in order to continually check the change of the sharing variable, the processor needs to maintain the active state, not the idle state. Hence, the spin-wait scheme may increase the power consumption of the processor as the instruction for confirmation of the sharing variable of the sharing memory is continually performed.

Hence, the multi-threading program according to an embodiment of the present invention minimizes the waiting time of the thread until the value of the sharing variable is delivered to the thread through the sharing memory in the synchronization process which uses the sharing variable of the sharing memory, and tries to maintain the process in the idle state in order to reduce the power consumption of the processor.

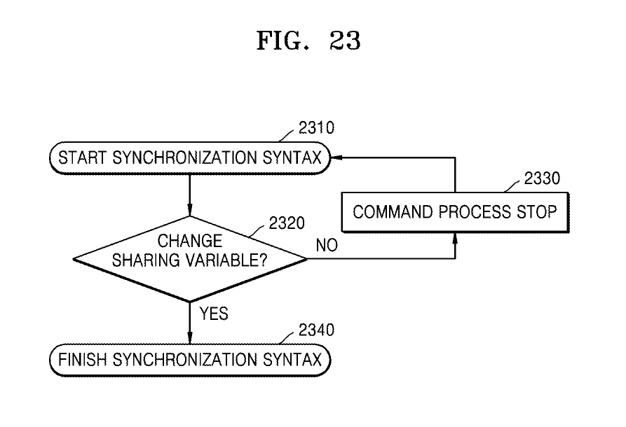

FIG. 23 is a flowchart illustrating a synchronization process of a multi-threading program according to an embodiment of the present invention.

Referring to FIG. 23, in operation 2310, a synchronization syntax is started. In operation 2320, it is checked whether the sharing variable is to be changed, and when there is no change in the sharing variable, in operation 2330, the processor stop command is executed. If the processor stop command is executed, the processor is maintained in the idle state until an interrupt occurs, and thus the power consumption of the processor is reduced. The processor stop command may be stopped by an interrupt, and scheduling is possible so that other threads and processes may be executed. When the processor is in an idle state, whether the sharing variable is changed may be checked after getting out of the idle state by the timer interrupt which is periodically executed in the system. That is, the processor may be maintained in the idle state by allowing whether the sharing variable is changed to be periodically checked without a separate scheduling process. According to the synchronization process of the multi-threading program according to an embodiment of the present invention, the power consumption of the processor may be reduced by checking whether the sharing variable is changed for respective minimum scheduling periods without latency reduction due to the scheduling. Further, quick reactivity may be secured compared to the synchronization scheme, which uses the semaphore, by checking whether the sharing variable is changed with the minimum time criterion which allows scheduling, e.g. for respective timer interrupt periods.

As described above, according to the one or more of the above exemplary embodiments, the speed of a video decoding process may be improved by identifying pictures which may be processed in parallel in the video decoding process and decoding such pictures in parallel.

The present invention may be implemented as a code which may be read by a computer in a computer-recording medium. The computer-readable recording medium includes all kinds of recording devices where data, which may be read by a computer system, is stored. Some examples of the computer-readable recording medium are ROM, RAM, CD-ROM, a magnetic tape, a floppy disk, and an optical data storage device. Further, the computer-readable recoding medium may be distributed in a computer system connected by a network and may be stored and executed as a code which may be read by a computer in a distributed manner.

It should be understood that the exemplary embodiments described therein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A video encoding method for a parallel process, the video encoding method comprising:
performing an inter prediction and an intra prediction for pictures included in a group of picture (GOP) and determining an encoding order and reference dependency between the pictures included in the GOP; and
generating a predetermined data unit including reference relation information generated based on the encoding order and reference dependency between the pictures included in the GOP.

2. The video encoding method of claim 1, wherein the reference relation information is a reference dependence tree which is generated by positioning a picture referenced by the pictures within the GOP at a parent node and positioning a picture which reference the picture of the parent node at a child node based on the encoding order and reference dependency.

3. The video encoding method of claim 2, wherein, when a plurality of pictures which reference the picture of the parent node may be processed in parallel, the reference dependency tree is formed so that the plurality of pictures may be included in the child node of the same layer.

4. The video encoding method of claim 1, wherein the predetermined data unit is a network adaptive layer (NAL) unit, and the reference relation information is included in a supplemental enhancement information message (SEI) including additional information from among the NAL units.

5. A video encoding apparatus for a parallel process, the video encoding apparatus comprising:
an image encoder which performs an inter prediction and an intra prediction for pictures included in a group of picture (GOP) and determines an encoding order and reference dependency between the pictures included in the GOP; and
an output unit which generates a predetermined data unit including reference relation information generated based on the encoding order and reference dependency between the pictures included in the GOP.

6. The video encoding apparatus of claim 5, wherein the reference relation information is a reference dependence tree which is generated by positioning a picture referenced by the pictures within the GOP at a parent node and positioning a picture which reference the picture of the parent node at a child node based on the encoding order and reference dependency.

7. The video encoding apparatus of claim 5, wherein the predetermined data unit is a network adaptive layer (NAL) unit, and the reference relation information is included in a supplemental enhancement information message (SEI) including additional information from among the NAL units.

8. A video decoding method for a parallel process, the video decoding method comprising:
obtaining a predetermined data unit including reference relation information generated based on a decoding order and reference dependency between pictures included in a group of picture (GOP);
determining pictures which may be processed in parallel from among pictures included in the GOP, based on reference relation information included in the data unit; and
decoding the determined pictures in parallel.

9. The video decoding method of claim 8, wherein the reference relation information is a reference dependence tree which is generated by positioning a picture referenced by the pictures within the GOP at a parent node and positioning a picture which reference the picture of the parent node at a child node based on the encoding order and reference dependency.

10. The video decoding method of claim 8, wherein the determining of the pictures which may be processed in parallel includes determining pictures which are included in a lower part of the parent node and are included in a child node of the same layer, as pictures which may be processed in parallel.

11. The video decoding method of claim 8, wherein the predetermined data unit is a network adaptive layer (NAL) unit, and the reference relation information is included in a supplemental enhancement information message (SEI) including additional information from among the NAL units.

12. A video decoding apparatus for a parallel process, the video decoding apparatus comprises:
a receiver which obtains a predetermined data unit including reference relation information generated based on a decoding order and reference dependency between pictures included in a group of picture (GOP); and
an image decoder which determines pictures which may be processed in parallel from among pictures included in the GOP, based on reference relation information included in the data unit, and decodes the determined pictures in parallel.

13. The video decoding apparatus of claim 12, wherein the reference relation information is a reference dependence tree which is generated by positioning a picture referenced by the pictures within the GOP at a parent node and positioning a picture which reference the picture of the parent node at a child node based on the encoding order and reference dependency.

14. The video decoding apparatus of claim 12, wherein the determining of the pictures which may be processed in parallel includes determining pictures which are included in a lower part of the parent node and are included in a child node of the same layer, as pictures which may be processed in parallel.

15. The video decoding apparatus of claim 12, wherein the predetermined data unit is a network adaptive layer (NAL) unit, and the reference relation information is included in a supplemental enhancement information message (SEI) including additional information from among the NAL units.
